(19) United States
(12) Patent Application Publication
(10) Pub. No.: US 2018/0209789 A1
(43) Pub. Date: Jul. 26, 2018

(54) SYSTEM AND METHOD OF ACQUIRING ROAD DATA

(71) Applicant: International Business Machines Corporation, Armonk, NY (US)

(72) Inventors: Reginald Eugene BRYANT, Nairobi (KE); Aisha WALCOTT, Nairobi (KE); John Mbari WAMBURU, Nairobi (KE); Komminist S. WELDEMARIAM, Nairobi (KE)

(21) Appl. No.: 15/440,885

(22) Filed: Feb. 23, 2017

(30) Foreign Application Priority Data
Jan. 23, 2017 (KE) 2017-2596

(51) Int. Cl. G01C 7/04; G01C 15/00; G01C 21/36; G06K 9/00; G06K 9/62; G06K 9/66; G08G 1/01; G08G 1/04; G08G 1/0967; H04M 1/725; H04W 4/02

(52) U.S. Cl. CPC G01C 7/04; G08G 1/0125; G01C 21/3647; G06K 9/00805; G06K 9/6267; G06K 9/66; G08G 1/0112; G08G 1/0129; G08G 1/0133; G08G 1/0141; G08G 1/04; G08G 1/0967; H04M 1/72572; H04W 4/02; G06K 9/00798; G08G 1/0104; G08G 1/0108; G01C 15/00

(57) ABSTRACT

A system for acquiring road data includes a resource analyzer for analyzing resources used by a device on a vehicle, a context analyzer for setting a context for data valuation and decision making based the analyzed resources, a data evaluator for evaluating data based on the set context, a decision engine for determining data to acquire based on the set context, and a data acquisition device for acquiring the determined data.

### BACKGROUND

The present invention relates generally to a system and method for acquiring road data and, more particularly, to a system and method for acquiring road data which determines data to acquire based on a set context, and acquires the determined data.

A related art system monitors vehicle sensors to determine and report road quality using a communication device. The communication device determines the vehicle's location on a road, such as by use of a GPS-enabled head unit or similar device and appropriate mapping software. Monitoring road quality may be achieved by adding a sensor to the shocks, by use of a vertical displacement sensor present on the head unit, and the like.

Various combinations of sensors may be employed. A horizontal displacement sensor may be used. The signals from the sensors are monitored by the head unit and analyzed to judge the quality of the road by the amount of vertical vibration that is encountered. This data, together with the vehicle's location, may be transmitted through a mobile network to a central server for distribution in road quality reports and to improve driving directions in mapping software.

### SUMMARY

An exemplary aspect of the present invention is directed to a system for acquiring road data includes a resource analyzer for analyzing resources used by a device on a vehicle, a context analyzer for setting a context for data valuation and decision making based the analyzed resources, a data evaluator for evaluating data based on the set context, a decision engine for determining data to acquire based on the set context, and a data acquisition device for acquiring the determined data.

Another exemplary aspect of the present invention is directed to a method of acquiring road data. The method includes analyzing resources used by a device on a vehicle, setting a context for data valuation and decision making based the analyzed resources, evaluating data based on the set context, determining data to acquire based on the set context, and acquiring the determined data.

Another exemplary aspect of the present invention is directed to a computer program product for acquiring road data, the computer program product comprising a computer readable storage medium having program instructions embodied therewith, the program instructions executable by a computer to cause the computer to analyze resources used by a device on a vehicle, set a context for data valuation and decision making based the analyzed resources, evaluate data based on the set context, determine data to acquire based on the set context, and acquire the determined data.

With its unique and novel features, the exemplary aspects of the present invention may provide a system and method for acquiring road data which requires little or no maintenance and is less expensive than related art systems and methods.

### BRIEF DESCRIPTION OF THE DRAWINGS

The exemplary aspects of the present invention will be better understood from the following detailed description of the exemplary embodiments of the invention with reference to the drawings, in which:

FIG. 1 illustrates a system 100 for acquiring data, according to an exemplary aspect of the present invention.

FIG. 2 illustrates a method 200 of acquiring road data, according to an exemplary aspect of the present invention.

FIG. 3 illustrates a system 300 for acquiring data, according to an exemplary aspect of the present invention.

FIG. 4 illustrates a data valuation algorithm 400 that may be implemented by the collected data evaluator 330, according to an exemplary aspect of the present invention.

FIG. 5 illustrates an interactive map 500 which may be generated by the system 300, according to an exemplary aspect of the present invention.

FIG. 6 depicts a cloud computing node according to an exemplary aspect of the present invention.

FIG. 7 depicts a cloud computing environment 50 according to an exemplary aspect of the present invention.

FIG. 8 depicts abstraction model layers according to an exemplary aspect of the present invention.

### DETAILED DESCRIPTION

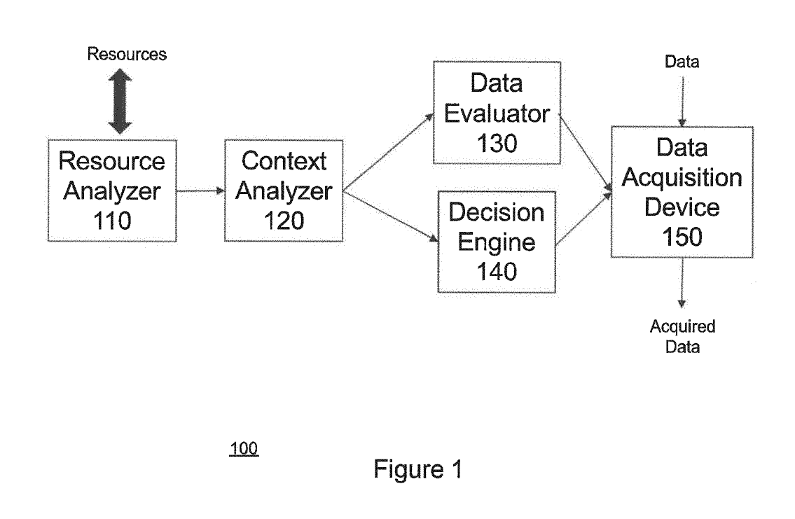

The invention will now be described with reference to FIGS. 1-8, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

Mobility in rapidly urbanizing developing cities is critical for the movement of people, goods, and services, particularly in Africa. There is little or no freight, air, or rail infrastructure as an alternative means of transport causing a number of mobility challenges. Roadways are heavily burdened as the primary resource for transport. Most road networks infrastructure are unable to keep pace with their demand. For example, it has been determined that the city of Nairobi, Kenya has road capacity for a population one third its size.

Another challenge is that most of the roadways are shared with pedestrians a wide variety of transport modes including tuc-tucs (3-wheel cars), pushcarts, motorcycles, and bicycles, in addition to cars and heavy goods vehicle. There is little or no infrastructure or space such as sidewalks or bike lanes, to support all transport modes.

Moreover, traffic lanes in developing cities are narrow and there is little redundancy in the road network which can lead to high traffic congestion levels and unpredictable travel time estimates. Slower vehicles (and pedestrians) cause moving bottlenecks, and drivers often execute risky driving maneuvers to navigate the busy, narrow roadways. Additionally, many roads suffer from potholes, cracks, and so forth due to little or no ongoing maintenance, creating treacherous driving conditions particularly in bad weather like heavy rains. It is no wonder, therefore, that developing countries in Africa are among the highest for traffic related deaths in the world.

Data is one of the critical missing factors to support intelligent development of infrastructure and traffic management systems for resource-constrained environments. Traditional sources for data such as traffic cameras are cost prohibitive for developing cities. As a result, new approaches for data collection requiring little or no maintenance are needed to provide cities with the necessary information for investment, planning, and decision support.

In addition to new methods for data collection, modeling locally relevant contextual factors is also important. For example, creating a model of road quality allows a system to capture and derive the impact that potholes and other poor surface conditions have on vehicle flows.

Vehicles may never be able to reach the intended speed limit due to slowing speeds to navigate around potholes, or a crowded-roadway may cause vehicles to swerve into oncoming traffic while avoiding school children. These local roads and navigation factors are often left-out of mapping tools such as Open Street Maps and Google Maps, and therefore their impact on traffic is not captured.

The rise in access to mobile technology in developing cities provides a new method for capturing infrastructure data including local factors. Most smartphones come equipped with an array of sensing capabilities including inertial sensors such as accelerometer and gyroscope, as well as a global positioning system (GPS) device.

While mobile technology mounted in vehicles can be used as a source of transport and infrastructure data, there still remains a number of issues that must be considered especially with respect to on and off-device resources such as power, network capability, and data costs. Traditional systems for roads monitoring and maintenance are challenging to implement in developing cities. These systems often require costly sensing infrastructure in and around the roadways.

For developing cities, such systems are cost-prohibitive. At the same time, there is an ever-increasing need for infrastructure planning and maintenance systems in developing cities as they are unable to keep pace with rapid urbanization. This is primarily due to the costs and requisites to maintain such sensing technologies.

The availability of low-cost sensors in smartphones and the rapid increase in the rate of smartphone users in developing countries has led to the development of systems which are able to detect road conditions using sensors present in smartphones. However, limited network connectivity and the high cost of connection continues to be a hindrance to the widespread usage of such systems. Mobile data connection shows intermittent behavior—it is relatively strong in some locations, but prohibitively slow in most areas.

Given the resource constrained nature and contextual variability (e.g., variation in cost and coverage, 2G/3G/WiFi connection points geo-spatially, device on vehicle and moving, power management, etc.), the inventors sought to develop a dynamically configurable system which can collect events at different resolutions as required. Such events may be generally first stored locally (e.g., in a user device such as a phone or tablet) and then periodically sent over (e.g., via wireless link) to a server where the data can be persisted and made available to consuming applications for analysis.

Thus, the exemplary aspects of the present invention may address at least four key challenges in acquiring road data.

1. Cost of Data

Drivers in developing countries are very sensitive to use existing mobility apps due to the cost of data. For example, most mobile phone users in Kenya may choose to top-up mobile data bundles in low increments, which is evidence by the top-up amounts offered by a Telco operator in Kenya: 5 to 50 KES for 5 to 150 MB of data for a period ranging from 24 hours to 7 days.

Since most people use mobile data for the majority of their online activities (e.g., social media services like Facebook and Twitter), it is possible that by using navigation apps (especially the process of downloading map tile data) most of a user's data bundle can be consumed fairly quickly and the device battery power can be drained as well. As a result, energy consumption and mobile data cost are two main factors affecting users' participation in crowdsensing tasks.

2. Limited Use of Navigation Systems

There are a large fraction of drivers in cities across developing countries use mobile phones that run alternative operating systems (e.g., Symbian, WM and Blackberry) which companies like Waze specifically express a disinterest in supporting. Furthermore, the use of dedicated car navigation systems is rare. Such a rarity in usage may be attributed to driver's familiarity with the roadway network as well as the low redundancy of the roadway network (i.e., limited alternative travel path options).

3. Network Connectivity Issues

While attempting to introduce an intelligent data collection system in these cities, mobile devices often operate in resource constrained environments. In the case of resource-constraints, they terminate data collection or halt the system/device operation. Thus, in resource constrained environments, mobility data collection can pose challenges because in such environments, intermittent or/lack of network connectivity prevents data from being updated regularly to the server and limited storage capabilities on the device do not allow all of the data to be saved.

It is common for drivers to have access to mobile phones (e.g., procured by themselves or donated by government or other organizations). However, drivers may only have intermittent network or Internet connectivity, and sometimes not have connectivity for extended periods of time.

4. Activity Suspension

During in-field tests, it is a common practice to remove the vehicle's battery for several days. Such a practice necessitated the use of a sufficiently large external, rechargeable (lithium ion) battery in conjunction with an intelligent device hibernation policy during times of vehicle inactivity.

In the event of being fully discharged, the devices were configured to suspend all activity until 10 minutes elapsed, upon which the devices would fully power up and continue data collection. The 10-minute wait period was based on the charging behavior of a relatively new lithium battery, active device processes as well as the sensor activation policies (e.g., the frequency at which sensor measurements are acquired).

Thus, the exemplary aspects of the present invention may incorporate a more flexible and responsive suspension policy which would take into the account of battery age and device processor load.

Referring again to the drawings, FIG. 1 illustrates a system 100 for acquiring data, according to an exemplary aspect of the present invention.

As illustrated in FIG. 1, the system 100 includes a resource analyzer 110 for analyzing resources used by a device (e.g., cellular telephone) on a vehicle, a context analyzer 120 for setting a context for data valuation and decision making based the analyzed resources, a data evaluator 130 for evaluating data based on the set context, a decision engine 140 for determining data to acquire based on the set context, and a data acquisition device 150 for acquiring the determined data.

The resource analyzer 110 may determine, for example, an amount of the resources available to the device. The resources analyzed by the resource analyzer 110 may include, for example, an energy source (e.g., a battery in a cell phone), a storage device (e.g., memory in a cell phone), a network data connection (e.g., a service connection for a cell phone), and available memory on the device.

The resource analyzer 110 may also monitor ongoing and planned activities on the device (e.g., applications running on the device) and estimate an amount of resources required to acquire road data. Further, the resource analyzer 110 may maintain resource-usage logs, track ongoing resources, track ongoing running applications on the device, and schedule future allocations of the resources.

In particular, the resource analyzer may track ongoing resources by using a configurable adaptive event framework module that instruments and collects data from one or more on-device sensors, on-vehicle sensors, applications running on the devices, etc. The resource analyzer may compute a resource index, for example, by determining current resources in use, an estimated number of resources required for a planned activity, and a history of resource indices for the device. The resource index may represent, for example, an amount of resources available for the device to execute a task.

Referring again to FIG. 1, the context analyzer 120 may dynamically set a context for data valuation and decision making by using a value of the resource index and analysis of contextual information. Such contextual information may include, for example, social media, probe vehicles, and traffic conditions. In particular, the context analyzer 120 may dynamically set the context by using a user schedule from an electronic calendar.

The data evaluator 130 may evaluate data by using, for example, machine learning, statistics, summarization and clustering. The decision engine 140 may generate a decision table including a list of activities, use an encoded strategy to execute the activities, and use a graphical user interface (GUI) to present the decision table for a user (e.g., a remote user).

The system 100 may also include a connection cost estimator which estimates a connection cost for the device (e.g., cell phone) based on analysis of a network connection.

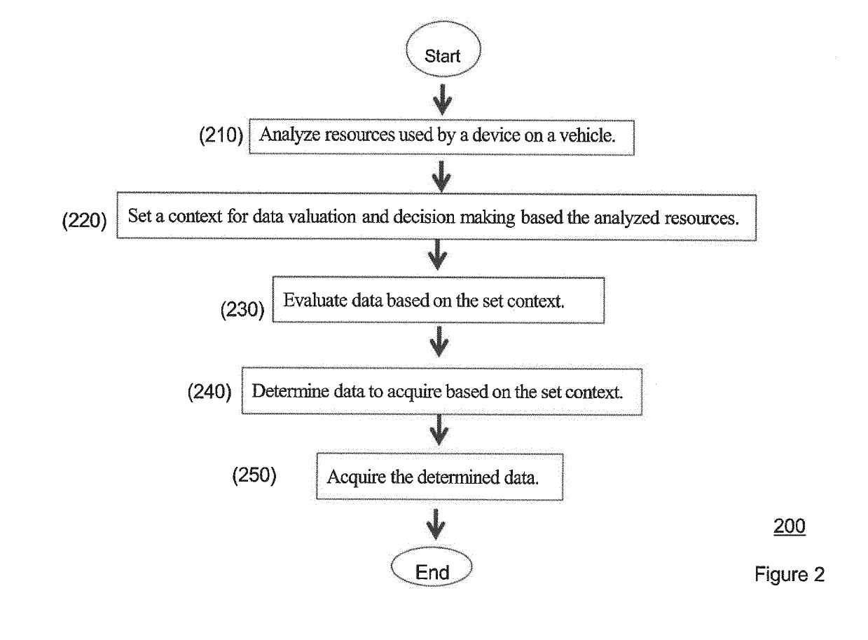

Referring again to the drawings, FIG. 2 illustrates a method 200 of acquiring road data, according to an exemplary aspect of the present invention.

As illustrated in FIG. 2, the method 200 includes analyzing (210) resources used by a device (e.g., cell phone) on a vehicle, setting (220) a context for data valuation and decision making based the analyzed resources, evaluating (230) data based on the set context, determining (240) data to acquire based on the set context, and acquiring (250) the determined data.

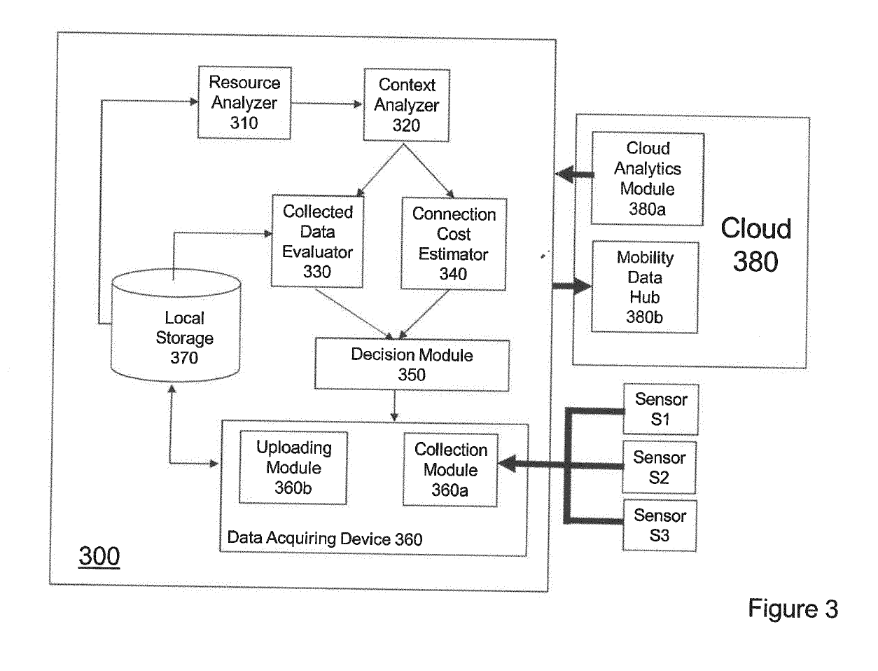

FIG. 3 illustrates a system 300 for acquiring data, according to an exemplary aspect of the present invention.

As illustrated in FIG. 3, the system 300 may include a resource analyzer 310, a context analyzer 320, a collected data evaluator 330, a connection cost estimator 340, a decision module 350 which may perform summarization of the data, compaction of the data, uploading of the data, etc. and a data acquiring device 360. The data acquiring device 360 may include a collection module 360a and an uploading module 360b. The system 300 may also include a local storage 370 which may store events (e.g., history data) models, etc.

The system 300 may also be communicatively coupled (e.g., by wireless connection) to the cloud 380 (e.g., cloud-backend for a cognitive mobility system). The cloud 380 may include cloud analytics 380a and a mobility data hub 380b.

In a particular embodiment, the system 300 may 1) assess resource constraints C, 2) determine or evaluate the value V of road events (e.g. potholes, other hazards, etc.), 3) assess resource risk R associated with collecting and uploading events based on the constraints (e.g., phone will turn off in 4 minutes, bandwidth signal will be too low in 2 minutes), 4) assess driver cohorts DC (e.g. type of vehicle, purpose of vehicle, driver behavior), and 5) based on a function-of (C, V, R, DC), trigger one or more operations.

It should be noted that elements of the system 300 may be included, for example, in a device (e.g., in a cell phone). For example, a cell phone on a vehicle may include a processing device (e.g., microprocessor) which executes software instructions to perform the features of the elements of the system 300 (e.g., resource analyzer 310, context analyzer 320, etc.).

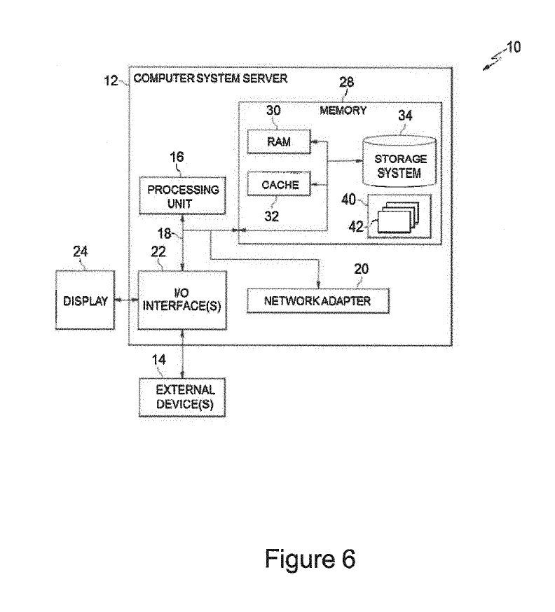

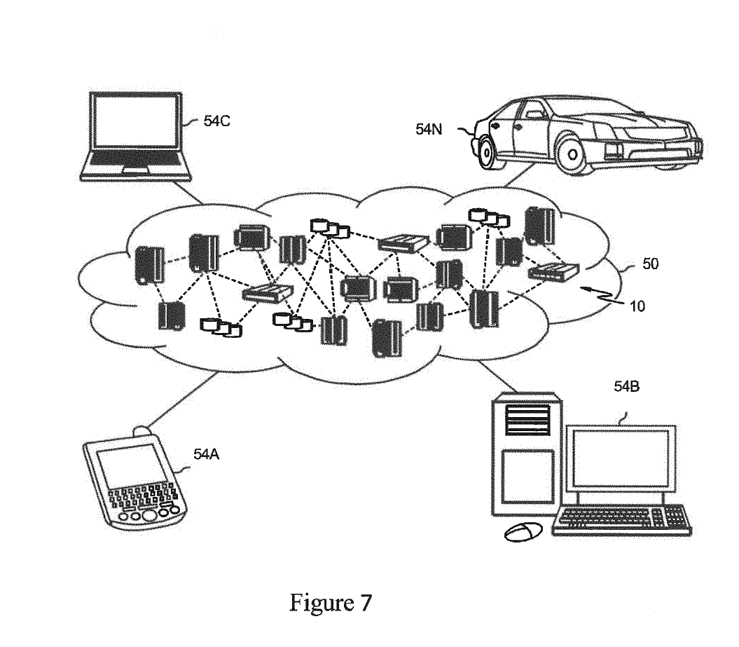

The system 300 may be wirelessly connected to a network (e.g., the Internet), and the system 300 may access and be accessed by the cloud 380 (e.g., see FIGS. 6 and 7 below) via the network. The type of network may include, for example, a 2G network, a 3G network, a 4G network, Wifi, etc.

The system 300 may also include one or more sensors S1, S2, S3 such as a GPS sensor, accelerometer, gyroscope, etc. The sensors S1-S3 may be formed (e.g., embedded) in the device (e.g., mobile device). The sensors S1-S3 may also be formed in the vehicle on which the device is located, or may be formed remotely, such as a server which is remotely connected to the device via a wireless link. The sensors S1-S3 may be deployed inside public transport vehicles (e.g., buses and taxies) and government or municipal vehicles (e.g., waste collection trucks) that operate at least somewhat regularly (e.g., on a weekly, daily or hourly basis).

The various analytics modules of the system 300 (e.g., resource analyzer 310, etc.) may use the collected data to generate insights related to road infrastructure, driver behavior (e.g., driver feedback for warning against potholes and driver behavior hazards), traffic congestion, etc. In one exemplary embodiment, the system 300 may acquire road data, and feed (e.g., wirelessly) the acquired road data to an existing decision support system which may be used by government transportation and road authorities for accountable decision making (e.g., road planning and maintenance).

The system 300 may monitor the levels of on-device resources (e.g., low battery, bandwidth, storage, etc.) and the levels of off-device resources (e.g. network type, availability and the location and strength of network types and signals) by using machine learning or statistical models. The system 300 may determine an expected variation of network signal type and/or strength (e.g., expecting 4G connection in the next 4 minutes heading east on specific road) as well as context information to determine the next action to perform (e.g., there is 4 MB of storage space left with poor connectivity and there is no more space to store data).

The system 300 may decide to summarize the data to free up space, and when enough connectivity is available, the uploading module 360b may send data which has been collected by the collection module 360a over to the cloud 380 (e.g., a cloud server) where the data can be persisted and made available to consuming applications for analysis. The cloud 380 may include a cloud analytics module 380a which analyzes, for example, road quality, moving traffic obstacles, driver behavior, etc. The cloud 380 may also include a mobility data hub (MDH) 380b which stores mobility data.

The resource analyzer 310 may determine the amount of resources which are available on a vehicle mounted device. Such resources may include, for example, battery level, storage space, data connectivity, etc. The resource analyzer 310 may negotiate resources and optimize resources in order to carry out ongoing and planned on-device activities efficiently.

In particular, with an internal usage and task tracker function, the resource analyzer 310 may monitor the ongoing and planned activities (i.e. activities related to applications and devices or sensors) on the device (e.g., cell phone) and estimate the amount of resources required to acquire (e.g., collect) road data for the next time T duration.

For example, a truck may have two collection points remaining from daily assigned tasks. Based on previous collection routes, an average time T duration is needed to complete the route and pickups. While on the route, the likely number of events E will consume some amount of space (KB), and thus, a minimum of C KB of connectivity and S KB event storage is projected for the completing the route.

The resource analyzer 310 may also perform the following functions: a) maintain the resource-usage logs, (2) track ongoing resources (3) schedule future resource allocations. The resource logs may be generated in order to properly allocate resources as the vehicles (e.g., vehicles on which the device containing the system 300 are located) are driven. For example, in these logs, items like network type (e.g., 2G, 3G etc.), and battery discharge rates are cached in order to allow the resource analyzer 310 to effectively manage resources as sensor information is collected from the sensors S1-S3 during vehicle drives. For ongoing resource tracking, the resource analyzer 310 may formulate a resource index (RI) which captures on-device resources (battery level, active sensors, sensor sampling frequency) and off-device resources (e.g., resources that are external to the device) such as GPS accuracy, upload data rates and so on.

Using a real-time resource tracking module, the resource analyzer 310 may decide to choose which sensors S1-S3 to activate or deactivate, the rate at which the sensors S1-S3 are collecting data, the optimal time to upload saved data, and whether to continue data uploading. Resource scheduling may be informed both from the logs and current device operation captured from the RI for future usage.

The resource index (RI) for a device (e.g., a device including the system 300) represents a score that may determine the amount of resources available for the device to execute any task. The index is computed by determining the current resources in use, the estimated number of resources required for planned activities, and the history of resource indices for the device.

The resource analyzer 310 may publish the collected data in the form JSON structure ([r_battery: 0.56, r_storage: 0.9, r_cpu: 0.4, <r_process: 14>, . . . ]) into the collection module 360a (e.g., collection controller) and upload module (360b) (e.g., upload controller) of the data acquiring device 360.

The context analyzer 320 may set the context for data valuation in the collected data evaluator 330 and for decision making in the decision module 350. The context analyzer 320 may rely on the resource index (RI) values and other contextual information including social media, probe vehicles, traffic conditions.

In addition, the context analyzer 320 may incorporate learning models. The context analyzer 320 may incorporate off-devices constraints including network availability and the location and strength of network types and signals on a map.

The collected data evaluator 330 may determine the value of data based on the uniqueness of sensor event signal, and the sum of records collected in the same location. The data valuation function of the collected data evaluator 330 may determine the value of data based on the uniqueness of sensor event signal, and the sum of records collected in the same location.

The system 300 may be configured to have several embodiments and features. For example, the system 300 may attempt to detect a possible presence of anomalies from the collected road data (e.g., sensor data) which potentially signify potholes, speed bumps or other hazards present on the road section.

The system 300 may also analyze readings on the Z-axis of accelerometer which always points to the ground. The amplitude, calculated as the difference between the maximum and minimum value of the vertical acceleration in each unit of time may then be used to determine the status of the current event.

High values of the amplitude may be labeled as anomalies. Consequently, signals with anomalies may have a higher data value than signals without anomalies. The accelerometer data may be filtered by means of a post-processing algorithm in order to remove low frequency components in the signal due to background noise. For example, the filtering may be performed by an equation like:

$$V = \{ \begin{matrix}0 & if V \leq {V}^{st} \\ V - {V}^{st} & if V > {V}^{st}\end{matrix}$$

where V^{st} is the maximum detected jerk in a stationary condition (at zero speed). This value may change, depending on the mobile device type. For this reason, the system 300 may be allowed to update the value by a recalculation whenever the application is started. In order to single out only the high-impulse events and to reject non-anomaly records, the signal may be filtered using:

$$V = \{ \begin{matrix}0 & if V \leq {V}^{th} \\ V - {V}^{th} & if V > {V}^{th}\end{matrix}$$

where V^{th} is the current value of accelerometer amplitude.

The system 300 may further keep track the cumulative count of how many times a specific location has been covered, and the number of records for each event may be identified. This count may be used as a divider in the overall data valuation function which brings in an inversely proportional dimension to the value of data. This, for example, can mean that when the device reaches a location for the first time, the value of that data will be higher compared to a location from which the device has already collected multiple records of data.

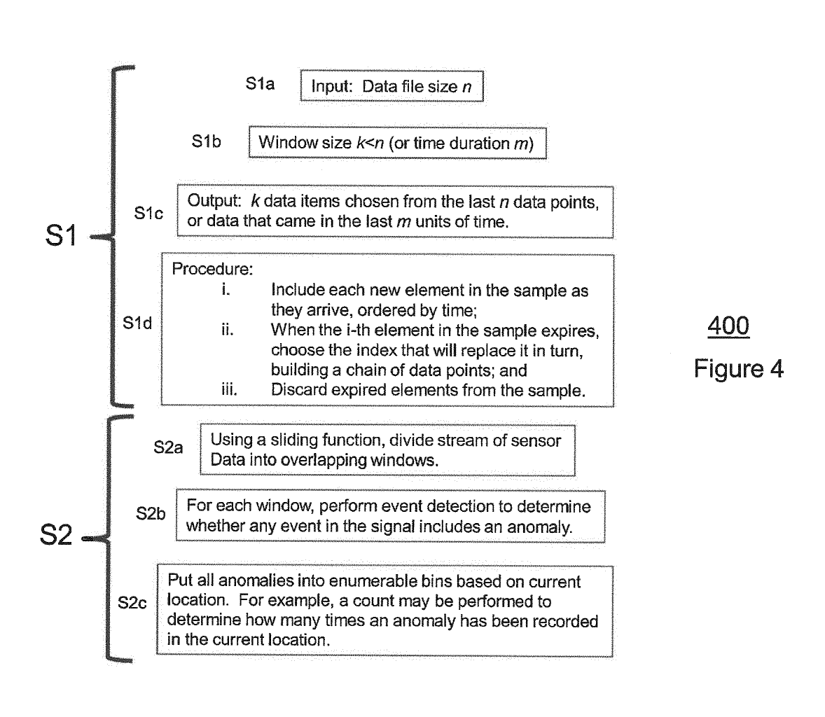

FIG. 4 illustrates a data valuation algorithm 400 that may be implemented by the collected data evaluator 330, according to an exemplary aspect of the present invention.

As illustrate in FIG. 4, the data valuation algorithm 400 may include two steps S1 and S2. The first step S1 includes Step S1a of inputting data file size n, Step S1b of utilizing a window size k<n (or time duration m), a Step S1c of outputting k data items chosen from the last n data points, or data that came in the last m units of time, and Step S1d of a procedure to:
i. Include each new element in the sample as they arrive, ordered by time;
ii. When the i-th element in the sample expires, choose the index that will replace it in turn, building a chain of data points; and
iii. Discard expired elements from the sample.

In the second step S2, the device may add events to historical event bins based on current location. The second step S2 includes Step S2a of, using a sliding function, dividing a stream of sensor data into overlapping windows, a Step S2b of, for each window, performing event detection to determine whether any event in the signal includes an anomaly, and Step S2c of putting all anomalies into enumerable bins based on current location. For example, in Step S2c, a count may be performed to determine how many times an anomaly has been recorded in the current location.

Referring again to FIG. 3, in the connection cost estimator 340, the estimation of the connection cost for the device may be determined by analyzing the types of network connections. The type of network connection may be of any: 2G, 3G, 4G, WiFi, etc. For example, a 2G network may be used to characterize the lowest quality of service and the highest cost of upload. In this case, the system 300 may only upload data while connected to this type of network when the data's time to server is critical.

A 3G network, on the other hand, may provide a relatively reliable quality of service and a reasonable cost of upload. The algorithm utilized by the system 300 may possibly wait for this network type to perform uploads.

The WiFi connection may provide a reliable quality of service and minimal cost incurred to perform upload. Therefore, the system 300 may trigger the upload operation to upload as much data as possible in this network. Thus, the system may decide to wait for this connection to perform upload whenever possible.

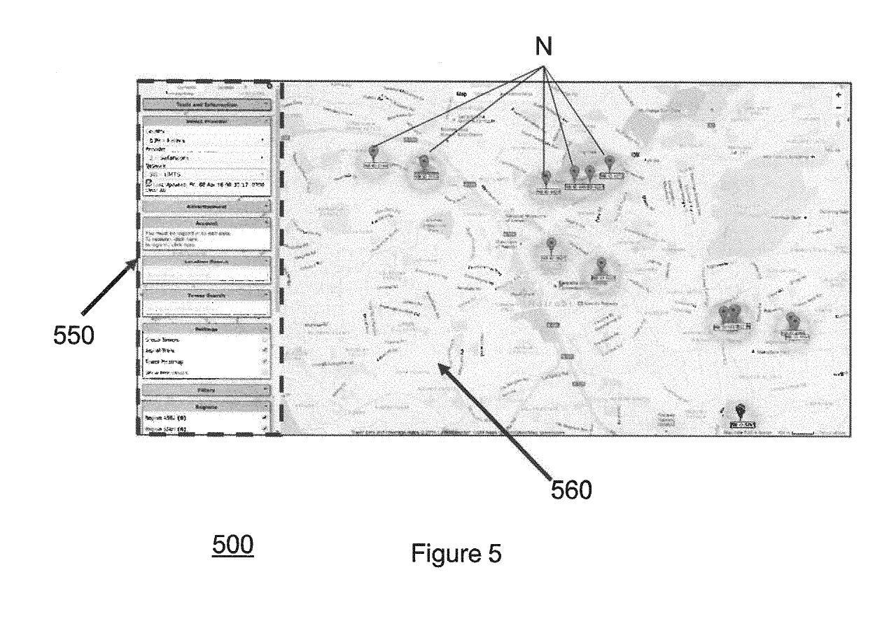

FIG. 5 illustrates an interactive map 500 which may be generated by the system 300, according to an exemplary aspect of the present invention. For example, the interactive map 500 may be generated by the decision module 350 and displayed on a display device (e.g., touchscreen) of the device (e.g., cell phone) which contains the system 300. The interactive map 500 may display a network distribution such as for a 3G network.

As illustrated in FIG. 5, the interactive map 500 may include a user interface portion 550 and a map portion 560. A location of the networks N may be illustrated on the map portion 560.

Referring again to FIG. 3, the decision module 350 may trigger an operation (e.g. drop, summarize, upload, etc.) by using a decision equation which defines the network connection, where each network type is represented by a tuple of the type and strength of connection. The two step decision function is described in FIG. 4.

The system 300 may allow a device to connect to either one of 2G or 3G connection types, and may have access to n WiFi points, where n is a natural number.

At any particular point in time, the device may have access to either one or two of the network types presented above, and may have a map (e.g., interactive map 500) which indicates where other types of networks are located. With this resource map (e.g., interactive map 500) and the heading of the device as input, the system 300 may calculate the estimated time of arrival at the next “Lower Cost Upload Point.”

Interestingly, the execution of one or more functions may be based on the decision module 350 dynamically. That is, the decision module 350 may initiate the uploading and/or downloading by utilizing the data evaluation result and the current context.

For example, the context analyzer 320 may suggest that after 5 minutes there is a need to collect data of approximately 100 MB, currently the network type is 3G with signal strength −96 dBm (may continue for the next 4 minutes); RI score as [<device_23, <r_battery, 0.53>, <r_storage, 0.4>, <r_#of process, 14>, <r_cpu, 0.5>, . . . ].

The decision module 350 may first generate a decision table including a list of activities e.g. 150 MB space needs to be freed, upload 50 MB data to MDH in the next 3-4 minutes (with 96 dBm signal strength), pause any data collection (this may trigger the various sensors S1-S3 (e.g. GPS, accelerometer, and gyroscope)) to stop collecting data until further instruction is sent, etc. The decision module 350 may then use various encoded strategies to execute these activities.

For example, to free up the Δ amount (e.g., Δ=150 MB), the decision module 350 may call an event summarization function which may apply one of the following functions to progressively compact the event data. This process may iterate until the requisite compaction is achieved.

In another embodiment, the decision module 350 may intelligently orchestrate the collection and uploading process based on values discussed above. For example, due to a poor connectivity signal (e.g. −112 dBm) and very low battery (5% left), both processes cannot be run in parallel. Thus, the decision module 350 may prioritize a sensing and collection process over the uploading process.

The collection and uploading modules 360a, 360b may include applications responsible for sensing the road (e.g., using embedded sensors such as GPS, accelerometer, and gyroscope, etc.) and collecting events (e.g., initially stored locally), and uploading data into a cloud-based data store (e.g., mobility data hub 380b).

In summary, the system and method of acquiring data may include an assessing resource constraints C, determine or evaluation the value V of road events (e.g. potholes, other hazards, etc.), assessing resource risk R associated with collecting and uploading events based on the constraint (e.g., phone will turn off in 4 minutes, bandwidth signal will be too low in 2 minutes), assessing driver cohorts DC (e.g. type/purpose of vehicle, driver behavior), and, based on the function of (C, V, R, DC), triggering one or more operations (e.g., applying an upload operation, applying a summarize operation, applying the summarize and upload operations, applying a drop operation, applying drop and upload operations, etc.).

The resource constraints C may be based on on-device (e.g., battery, bandwidth, storage) and off-device (e.g. network type, availability and the location and strength of network types and signals) constraints.

Further, a determination of the resource index (RI) for a device (which includes system 300) may be determined based on by monitoring the current resources in use, estimating the number of resources required to collect road data for the next time T duration, and analysis of history of resource indices for the device. The resource constraint may also be based on an assessment or forecast of off-device constraints. Such assessment or forecast may take into account the network type, availability and the location and strength of network types and signals.

Further, the context analyzer may dynamically set the context for data valuation and decision making using the resource index values (RI) and analysis of other contextual information (e.g. social media, probe vehicles, traffic conditions). For example, a truck may have two collection points remaining from daily assigned tasks. Based on previous collection routes, to determine the context for data valuation, an average T duration is needed to complete the route and pickups. While on the route, the likely number of events E will consume some amount of space (KB), and thus, a minimum file size of C KB must be uploaded requiring the appropriate network connectivity to upload on the fly and S KB event storage is projected for the completing the route.

The context analyzer may use a user schedule from an electronic calendar (e.g., the garbage collection truck may have two collection points remaining from daily assigned tasks).

A determination and evaluation of data may use various machine learning techniques (e.g., machine learning, statistical techniques, summarization and clustering algorithms) to determine the value of data based on the uniqueness of sensor event signal, and the sum of records collected in the same location or across locations. The data valuation algorithm may utilize the cumulative count of how many times a specific location has been covered and the number of records for each event may be identified.

Further, an estimation of the connection cost for the device may be based on an analysis of the types (2G, 3G, 4G, WiFi, etc.) of network connection. The different types may characterize the quality (low, medium, high) of service with associated cost (e.g. 2G may be considered to have a highest cost of upload, 3G may be considered to have a reasonable cost of upload, etc.).

The decision to execute an action may be based, for example, on resource index (RI) level of the device, the expected network signal type and strength (e.g., expecting 4G connection in the next 4 minutes heading east on specific road) and context information (e.g. connection cost and current vehicle location). Furthermore, the triggering (e.g. when and where) of an operation is algorithmically controlled and may be based on a network type to perform uploads.

The decision module may intelligently orchestrate the collection and uploading processes based on the values of the data as determined by the data evaluator. For example, due to poor connectivity signal (e.g. −112 dBm) and very low battery (5% left) both processes cannot be run in parallel, thus the decision module may intelligently prioritize “sensing and collection” process over the “uploading” process.

Further, in case of acute resource index (RI) and cost of data collection, the vehicle may communicate with nearby vehicles (road data collection) to decide any triggering action.

Referring to FIGS. 1-5, another aspect of the present invention is directed to a computer program product which may include, for example, a computer readable storage medium (hereinafter, the “storage medium”) that may store computer readable program instructions (hereinafter, the “computer program” or “instructions”) for performing the features and functions of the system 100, 300 for acquiring road data, and the method 200 of acquiring road data. That is, for example, the device including the system 100, 300 may include a storage medium that may store the instructions thereon for causing a processing device (e.g., computer, instruction execution device, computing device, computer processor, central processing unit (CPU), microprocessor, etc.) to perform a feature or function of the present invention.

The storage medium can be a tangible device that can retain and store the instructions for execution by the processing device. The storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The storage medium, as used herein, should not be construed as merely being a “transitory signal” such as a radio wave or other freely propagating electromagnetic wave, an electromagnetic wave propagating through a waveguide or other transmission media (e.g., light pulses passing through a fiber-optic cable), or an electrical signal transmitted through a wire.

The processing device can access the instructions on the storage medium. Alternatively, the processing device can access (e.g., download) the instructions from an external computer or external storage device via a network such as the Internet, a local area network, a wide area network and/or a wireless network.

The network may include, for example, copper transmission cables, optical transmission fibers, wireless transmission, routers, firewalls, switches, gateway computers and/or edge servers. For example, the processing device may include a network adapter card or network interface which receives the instructions from the network and forwards the instructions to the storage medium within the processing device which stores the instructions.

The instructions for performing the features and functions of the present invention may include, for example, assembler instructions, instruction-set-architecture (ISA) instructions, machine instructions, machine dependent instructions, microcode, firmware instructions, state-setting data, or either source code or object code written in one or more programming languages (or combination of programming languages), including an object oriented programming language such as Java, Smalltalk, C++ or the like, and conventional procedural programming languages, such as the “C” programming language or similar programming languages.

The instructions may execute entirely on the processing device (e.g., a user's computer), partly on the processing device, as a stand-alone software package, partly on the processing device and partly on a remote computer or entirely on the remote computer or a server. For example, the instructions may execute on a remote computer which is connected to the processing device (e.g., user's computer) through a network such as a local area network (LAN) or a wide area network (WAN), or may execute on an external computer which is connected to the processing device through the Internet using an Internet Service Provider.

The processing device may include, for example, electronic circuitry including, for example, programmable logic circuitry, field-programmable gate arrays (FPGA), or programmable logic arrays (PLA) that may execute the instructions by utilizing state information of the instructions to personalize the electronic circuitry, in order to perform a feature or function of the present invention.

It should be noted that the features and functions of the present invention which are described above with reference to FIGS. 1-5 may be implemented by the processing device executing the instructions. That is, each block of the flowchart illustrations and/or block diagrams, and combinations of blocks in the flowchart illustrations and/or block diagrams, can be implemented by processing device executing the instructions.

The instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

That is, the instructions may be executed by a processing device to cause a series of operational steps to be performed by the processing device to produce a computer-implemented process, so that the executed instructions implement the features/functions/acts described above with respect to the flowchart and/or block diagram block or blocks of FIGS. 1-5.

Thus, the flowchart and block diagrams in the FIGS. 1-5 illustrate not only a method, system, apparatus or device, but also illustrate the architecture, functionality, and operation of the processing device executing the instructions. In this regard, each block in the flowchart or block diagrams may represent a module, segment, or portion of the instructions, which comprises one or more executable instructions for implementing the specified logical function(s). In some alternative implementations, the features or functions in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring again to the drawings, FIGS. 6-8 illustrate other exemplary aspects of the present invention.

It is to be understood that although this disclosure includes a detailed description on cloud computing, implementation of the teachings recited herein are not limited to a cloud computing environment. Instead, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 6, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof.

This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

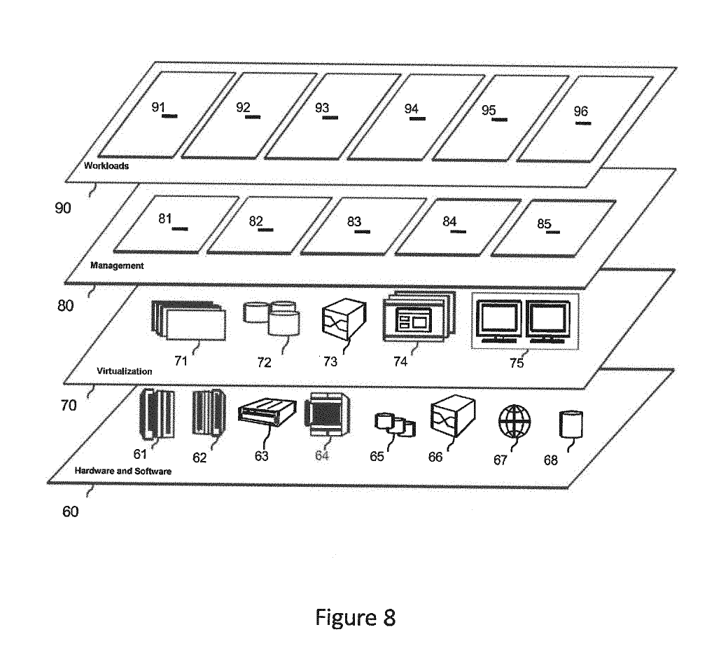

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and road data acquisition 96 in accordance with the present invention.

With its unique and novel features, the exemplary aspects of the present invention may provide a system and method for acquiring road data which requires little or no maintenance and is less expensive than related art systems and methods.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive method and system is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A system for acquiring road data, comprising:
a resource analyzer for analyzing resources used by a device on a vehicle;
a context analyzer for setting a context for data valuation and decision making based the analyzed resources;
a data evaluator for evaluating data based on the set context;
a decision engine for determining data to acquire based on the set context; and
a data acquisition device for acquiring the determined data.

2. The system of claim 1, wherein the resource analyzer determines an amount of the resources available to the device, and
wherein the resources analyzed by the resource analyzer comprise at least one of an energy source, a storage device, a network data connection, and available memory on the device.

3. The system of claim 1, wherein the resource analyzer monitors ongoing and planned activities on the device and estimates an amount of resources required to acquire road data.

4. The system of claim 1, wherein the resource analyzer:
maintains resource-usage logs;
tracks ongoing resources;
tracks ongoing running applications on the device; and
schedules future allocations of the resources.

5. The system of claim 4, wherein the resource analyzer tracks ongoing resources by using a configurable adaptive event framework module that instruments and collects data from at least one of an on-device sensor, an on-vehicle sensor, and an application running on the device.

6. The system of claim 5, wherein, based on the collected data, the resource analyzer computes a resource index by determining current resources in use, an estimated number of resources required for a planned activity, and a history of resource indices for the device, and
wherein the resource index represents an amount of resources available for the device to execute a task.

7. The system of claim 5, wherein the context analyzer dynamically sets the context for data valuation and decision making by using a value of the resource index and analysis of contextual information comprising at least one of social media, probe vehicles, and traffic conditions.

8. The system of claim 1, wherein the context analyzer dynamically sets the context by using a user schedule from an electronic calendar.

9. The system of claim 1, wherein the data evaluator evaluates data by using one of machine learning, statistics, summarization and clustering.

10. The system of claim 1, further comprising:
a connection cost estimator which estimates a connection cost for the device based on analysis of a network connection.

11. The system of claim 1, wherein the decision engine:
generates a decision table comprising a list of activities;
uses an encoded strategy to execute the activities; and
uses a graphical user interface (GUI) to present the decision table to a user.

12. A method of acquiring road data, comprising:
analyzing resources used by a device on a vehicle;
setting a context for data valuation and decision making based the analyzed resources;
evaluating data based on the set context;
determining data to acquire based on the set context; and
acquiring the determined data.

13. The method of claim 12, wherein the analyzing of the resources comprises determining an amount of the resources available to the device, and
wherein the resources analyzed comprise at least one of an energy source, a storage device, a network data connection and available memory on the device.

14. The method of claim 12, wherein the analyzing of the resources comprises monitoring ongoing and planned activities on the device and estimating an amount of resources required to acquire road data.

15. The method of claim 12, wherein the analyzing of the resources comprises:
maintaining resource-usage logs;
tracking ongoing resources;
tracking ongoing running applications on the device; and
scheduling future allocations of the resources.

16. The method of claim 15, wherein the tracking of the ongoing resources is performed by using a configurable adaptive event framework module that instruments and collects data from at least one of an on-device sensor, an on-vehicle sensor, and an application running on the device,
wherein the method further comprises:
based on the collected data, computing a resource index by determining current resources in use, an estimated number of resources required for a planned activity, and a history of resource indices for the device, and
wherein the resource index represents an amount of resources available for the device to execute a task.

17. The method of claim 12, wherein the setting of the context comprises dynamically setting the context for data valuation and decision making by using a value of the resource index and analysis of contextual information comprising at least one of social media, probe vehicles, and traffic conditions.

18. The method of claim 12, further comprising:
estimating a connection cost for the device based on analysis of a network connection.

19. The method of claim 12, wherein the determining of the data to acquire is performed by a decision engine, and the decision engine:
generates a decision table comprising a list of activities;
uses an encoded strategy to execute the activities; and
uses a graphical user interface (GUI) to present the decision table to a user.

20. A computer program product for acquiring road data, the computer program product comprising a computer readable storage medium having program instructions embodied therewith, the program instructions executable by a computer to cause the computer to:
analyze resources used by a device on a vehicle;
set a context for data valuation and decision making based the analyzed resources;
evaluate data based on the set context;
determine data to acquire based on the set context; and
acquire the determined data.
